(19) United States
(12) Patent Application Publication
(10) Pub. No.: US 2013/0086898 A1
(43) Pub. Date: Apr. 11, 2013

(54) BRAKE DEVICE OF ELECTRO-HYDRAULIC BRAKE SYSTEM FOR VEHICLES

(71) Applicant: Mando Corporation, Pyeongtaek-si (KR)

(72) Inventors: I Jin YANG, Seongnam-si (KR); Yong Suk HWANG, Seoul (KR); Byeong Hoo CHEONG, Gunpo-si (KR)

(73) Assignee: MANDO CORPORATION, Pyeongtaek-si (KR)

(21) Appl. No.: 13/648,074

(22) Filed: Oct. 9, 2012

(30) Foreign Application Priority Data
Oct. 7, 2011 (KR) 10-2011-0102376

(51) Int. Cl. F15B 15/18

(52) U.S. Cl. 60/413

(57) ABSTRACT

Disclosed herein is a brake device of an electro-hydraulic brake system for vehicles which provides hydraulic braking force to transmit stable pedal feel and provides regenerative braking for fuel efficiency improvement. The brake device includes an actuator unit including a master cylinder, a housing including a boosting chamber and a simulation chamber, an input rod, a reservoir connected to the upper portion of the master cylinder and storing oil, a simulator connected to the simulation chamber and a pedal displacement sensor sensing displacement of the pedal, and a hydraulic control unit. The hydraulic control unit includes an accumulator, a pump sucking oil from the reservoir and discharging the oil to the accumulator, a motor, a first control valve, a second control valve, a third control valve, pressure sensors sensing the pressures of the accumulator, the boosting chamber and the simulation chamber, and an electronic control unit (ECU).

### CROSS-REFERENCE TO RELATED APPLICATION

This application claims the benefit of Korean Patent Application No. 2011-0102376, filed on Oct. 7, 2011 in the Korean Intellectual Property Office, the disclosure of which is incorporated herein by reference.

### BACKGROUND

1. Field

Embodiments of the present invention relate to a brake device of an electro-hydraulic brake system for vehicles which provides hydraulic braking force to transmit stable pedal feel and provides regenerative braking for fuel efficiency improvement.

2. Description of the Related Art

Recently, development of hybrid vehicles, fuel cell vehicles and electric vehicles in order to improve fuel efficiency and reduce exhaust gas has been vigorously carried out. A brake device, i.e., a brake device of a brake system for vehicles, is essentially installed in such vehicles. Here, the brake device means a device which functions to decelerate or stop a driving vehicle.

In general, brake devices of brake systems for vehicles includes a vacuum brake generating braking force using suction pressure of an engine, and a hydraulic brake generating braking force using hydraulic pressure.

The vacuum brake exhibits large braking force at a small force through a vacuum booster using a difference between suction pressure of a vehicle engine and atmospheric pressure. That is, the vacuum brake generates output greater than force applied to a brake pedal when a driver presses the brake pedal.

In case of such a conventional vacuum brake, suction pressure of the vehicle engine is supplied to the vacuum booster to form a vacuum, and thereby fuel efficiency is lowered. Further, the engine is driven at all times to form the vacuum even when the vehicle is stopped.

Further, a fuel cell vehicle and an electric vehicle have no engine and thus application of the conventional vacuum brake amplifying driver's foot effort during braking to the fuel cell vehicle and the electric vehicle may be impossible, and a hybrid vehicle implements an idle stoppage function during stopping to improve fuel efficiency and requires introduction of a hydraulic brake.

That is, since implementation of a regenerative braking function is required to improve fuel efficiency in all vehicles, the regenerative braking function is easily implemented by employing a hydraulic brake.

In case of an electro-hydraulic brake system which is a kind of hydraulic brake, when a driver presses a pedal, an electronic control unit senses pressing of the pedal and supplies hydraulic pressure to a master cylinder, thereby transmitting hydraulic pressure for braking to a wheel cylinder of each wheel to generate braking force.

A brake device of such an electro-hydraulic brake system is configured to be easily controlled. However, an advanced electro-hydraulic brake system which secures safety of a vehicle during braking, improves fuel efficiency and has proper pedal feel has been required by users.

Therefore, according to the above requirement, research and development on an electro-hydraulic brake system which has a simple configuration, efficiently exhibits braking force even when a failure occurs and is easily controlled are underway.

### SUMMARY

Therefore, it is an aspect of the present invention to provide a brake device of an electro-hydraulic brake system for vehicles which improves safety in braking and a mounting property on a vehicle, has a simple configuration, provides stable pedal feel during braking, and support regenerative braking to improve fuel efficiency.

Additional aspects of the invention will be set forth in part in the description which follows and, in part, will be obvious from the description, or may be learned by practice of the invention.

In accordance with one aspect of the present invention, an electro-hydraulic brake system for vehicles to electronically control hydraulic pressure of a vehicle includes an actuator unit including a master cylinder having two hydraulic circuits and generating hydraulic pressure, a housing including a boosting chamber provided with a boosting piston contacting the master cylinder to compress the master cylinder, and a simulation chamber divided from the boosting chamber, an input rod disposed coaxially with the master cylinder to move forward by foot effort of a driver, provided within the housing, passing through the boosting piston, and having a regular clearance with a piston of the master cylinder, a reservoir connected to the upper portion of the master cylinder and storing oil, a simulator connected to the simulation chamber by a flow path and providing reaction force of a pedal, and a pedal displacement sensor sensing displacement of the pedal, and a hydraulic control unit connected to the reservoir and generating hydraulic pressure, wherein the hydraulic control unit includes an accumulator storing a designated level of pressure to supply the pressure to the boosting chamber, a pump sucking oil from the reservoir and discharging the sucked oil to the accumulator to form the pressure of the accumulator, a motor to drive the pump, a first control valve disposed at a flow path connecting the accumulator and the boosting chamber and controlling oil supplied from the accumulator to the boosting chamber, a second control valve disposed at a flow path connecting the boosting chamber and the reservoir and controlling oil discharged from the boosting chamber to the reservoir, a third control valve disposed at a flow path connecting the simulator and the reservoir and controlling oil flowing from the simulation chamber to the reservoir, pressure sensors sensing the pressures of the accumulator, the boosting chamber and the simulation chamber, and an electronic control unit (ECU) controlling operation of the motor and the control valves in response to signals from the pedal displacement sensor and the pressure sensors.

The first control valve serving as a pressure intensification control valve may be a normally close type solenoid valve which is closed in a normal state and is opened when the valve receives an opening signal from the ECU.

The second control valve serving as a pressure reduction control valve may be a normally open type solenoid valve which is opened in a normal state and is closed when the valve receives a closing signal from the ECU.

The third control valve serving as a cutoff valve may be a normally open type solenoid valve which is opened in a normal state and is closed when the valve receives a closing signal from the ECU.

The pressure sensors may include a first pressure sensor measuring the pressure of the accumulator, a second pressure sensor measuring the pressure of the boosting chamber, and a third pressure sensor measuring the pressure of the simulation chamber.

An insertion recess into which the input rod is inserted to form the regular clearance therebetween may be formed on the first piston of the master cylinder, and during abnormal operation, the input rod may move as much as the clearance with the piston and then mechanically contact the piston to transmit force applied to the input rod.

The hydraulic control unit may be a module integrated with a single housing block, and the hydraulic control unit being the integrated module may be assembled with the actuator unit.

An O-ring may be installed on the outer circumferential surface of the boosting piston so as to prevent the pressure and oil of the boosting chamber from leaking to the master cylinder.

An O-ring may be installed on the outer circumferential surface of one end of the input rod contacting a push rod of the pedal so as to prevent the pressure and oil of the simulation chamber from leaking to the outside of the simulation chamber.

A diaphragm may be formed within the housing so as to divide the boosting chamber and the simulation chamber from each other, and an O-ring may be provided between the input rod passing through the diaphragm and the diaphragm so as to isolate the pressure and oil of the boosting chamber and the pressure and oil of the simulation chamber from each other.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view schematically illustrating a brake device of an electro-hydraulic brake system for vehicles in accordance with one embodiment of the present invention;

FIG. 2 is a view illustrating an operating state of a hydraulic control unit if pedal displacement is generated during normal braking in the brake device in accordance with one embodiment of the present invention;

FIG. 3 is a view illustrating an operating state of the hydraulic control unit if pedal displacement is decreased or removed during normal braking in the brake device in accordance with one embodiment of the present invention; and

FIG. 4 is a view illustrating an operating state of the hydraulic control unit during emergency braking if the brake system malfunctions in the brake device in accordance with one embodiment of the present invention.

### DETAILED DESCRIPTION

Reference will now be made in detail to the embodiments of the present invention, examples of which are illustrated in the accompanying drawings, wherein like reference numerals refer to like elements throughout. The terms used in the following description are terms defined taking into consideration the functions obtained in accordance with the embodiments, and the definitions of these terms should be determined based on the overall content of this specification. Therefore, the configurations disclosed in the embodiments and the drawings of the present invention are only exemplary and do not include all of the technical spirit of the invention, and thus it will be appreciated that the embodiments may be variously modified and changed.

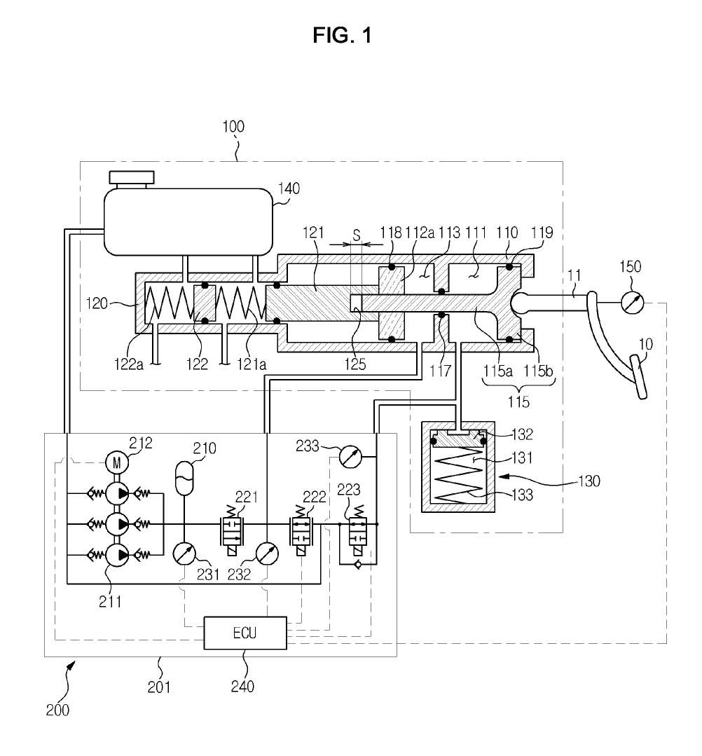

A brake device of an electro-hydraulic brake system in accordance with one embodiment of the present invention, as shown in FIG. 1, includes a housing 110 provided with a boosting chamber 112 and a simulation chamber 111, a master cylinder 120 connected to the housing 110, an input rod 115 disposed coaxially with the master cylinder 120 and provided within the housing 110 so as to move forward by foot effort of a driver, a reservoir 140 connected to the upper portion of the master cylinder 120 and storing oil, a simulator 130 providing reaction force of a pedal 10, a pedal displacement sensor 150 sensing displacement of the pedal 10, and a hydraulic control unit 200 connected to the reservoir 140 and generating hydraulic pressure.

The housing 110 is divided into the boosting chamber 112 and the simulation chamber 111, and the input rod 115 movable forward and backward is provided within the housing 110. An opening through which a push rod 11 of the pedal 10 and the input rod 115 contact is formed at one side of the housing 110. More concretely, a diaphragm 113 protruding to divide the boosting chamber 112 and the simulation chamber 111 from each other is provided within the housing 110, and the input rod 115 passes through the diaphragm 113. Here, an O-ring 117 is provided between the diaphragm 113 and the input rod 115 to hermetically seal the boosting chamber 112 and the simulation chamber 111 from each other.

A boosting piston 112a is provided in the boosting chamber 112, and an O-ring 118 is installed on the outer circumferential surface of the boosting piston 112a to prevent pressure and oil introduced into the boosting chamber 112 from leaking to the master cylinder 120. Such a boosting chamber 112 serves to compress the inside of the master cylinder 120 by pressure generated by foot effort of the driver. Thereby, the boosting chamber 112 receives oil of a high pressure to move pistons 121 and 122 provided within the master cylinder 120 forward and backward during normal braking. That is, the boosting chamber 112 is a space to receive oil of the high pressure, and, when oil of the high pressure generated by the hydraulic control unit 200 is supplied to the boosting chamber 112, the pistons 121 and 122 of the master cylinder 120 are moved by the oil and thus compresses oil within the master cylinder 120 and transmits the compressed oil to a wheel cylinder (not shown) to generate braking force.

The master cylinder 120 is provided with a first piston 121 and a second piston 122 so as to have two hydraulic circuits, and generates hydraulic pressure by the pressure of the above-described boosting chamber 112. The reason why the master cylinder 120 has two hydraulic circuits is to secure safety when the master cylinder 120 malfunctions. For example, one circuit from among the two hydraulic circuits is connected to a front right wheel and a rear left wheel of a vehicle, and the other circuit is connected to a front left wheel and a rear right wheel of the vehicle. In general, one circuit from among the two hydraulic circuits is connected to two front wheels and the other circuit is connected to two rear wheels. The reason for formation of two independent circuits is to facilitate braking of the vehicle even if one circuit malfunctions.

A first spring 121a and a second spring 122a are provided on the first piston 121 and the second piston 122 of the master cylinder 120. As the first spring 121a and the second spring 122a are compressed by the first piston 121 and the second piston 122, elastic force is stored in the first spring 121a and the second spring 122a. Such elastic force pushes the first and second pistons 121 and 122 to return the first and second pistons 121 and 122 to their original positions when force pushing the first piston 121 becomes less than the elastic force.

An insertion recess 125 into which the input rod 115 is inserted to form a designated clearance S therebetween is formed on the first piston 121 contacting the boosting piston 112a. That is, the input rod 115 passes through the boosting piston 112a and is separated from the bottom surface of the insertion recess 125 of the first piston 121 by a designated distance S. This is to allow the input rod 115 to move by the separation distance with the first piston 121 and then to contact the first piston 121 to transmit foot effort directly to the master cylinder 120, when the brake device in accordance with the embodiment of the present invention is abnormally operated.

As described above, the input rod 115 is provided so as to be movable forward and backward within the housing 110. The input rod 115 includes a pressing rod 115a passing through the diaphragm 113 and the boosting piston 112a, and a plunger 115b formed integrally with the end of the pressing rod 115a and extending toward the inner surface of the housing 110. Further, an O-ring 119 is installed on the outer circumferential surface of the plunger 115b to prevent pressure and oil of the simulation chamber 111 from leaking to the outside of the simulation chamber 111. Thereby, the pressure of the simulation chamber 111 is formed according to the displacement of the plunger 115b disposed within the simulation chamber 111. Such an input rod 115 contacts the push rod 11 installed on the pedal 10, and slides forward and backward together with the push rod 11 by foot effort on the pedal 10.

In accordance with the embodiment of the present invention, a pedal displacement sensor 150 is installed on the pedal 10 and senses the displacement of the pedal 10. A sensed signal is transmitted to an electronic control unit (ECU) 240 which will be described later, and the ECU 240 measures the displacement of the pedal 10 and controls a plurality of control valves 221, 222 and 223 provided on the hydraulic control unit 200 and controlling a flow of hydraulic pressure. Operation of the plural control valves 221, 222 and 223 according to the displacement of the pedal 10 will be described later.

Additionally, the pedal displacement sensor 150 may include a variable resistance-type stroke sensor or rotating angle sensor.

The simulator 130 is connected to the simulation chamber 111. Such a simulator 130 is provided with a chamber 131, and a reaction force piston 132 and a reaction force spring 133 are provided within the chamber 131. That is, when a driver presses the pedal 10, the reaction force piston 132 is moved by pressure generated by movement of the input rod 115 together with movement of the push rod 11, and then the reaction force piston 132 elastically compresses the reaction force spring 133. Here, elastic force stored in the reaction force spring 133 by compression of the reaction force spring 133 provides reaction force to the input rod 115 and the push rod 11, thus providing proper pedal feel to the driver.

The reservoir 140 is connected to the upper portion of the master cylinder 120 and supplies oil to the master cylinder 120 and the hydraulic control unit 200. The reservoir 140 is provided with outlets through which oil is discharged, and supplies oil to the master cylinder 120 through the outlets.

The hydraulic control unit 200 compresses oil supplied from the reservoir 140 and then supplies the oil to the boosting chamber 112.

A pump 211 sucking oil from the reservoir 140 and discharging the sucked oil to an accumulator 210 to form pressure of the accumulator 210 and a motor 212 to drive the pump 211 are provided in the hydraulic control unit 200, and oil of a high pressure compressed by the pump 211 is stored in the accumulator 210. That is, the accumulator 210 stores oil so as to have a designated level of pressure to supply pressure to the boosting chamber 112.

The hydraulic control unit 200 includes a first control valve 221 disposed at a flow path connecting the accumulator 210 and the boosting chamber 112 and controlling oil supplied from the accumulator 210 to the boosting chamber 112, a second control valve 222 disposed at a flow path connecting the boosting chamber 112 and the reservoir 140 and controlling oil discharged from the boosting chamber 112 to the reservoir 140, a third control valve 223 disposed at a flow path connecting the simulator 130 and the reservoir 140 and controlling oil flowing from the simulation chamber 111 to the reservoir 140, and the ECU 240 controlling the control valves 221, 222 and 223.

The first control valve 221 serving as a pressure intensification control valve is a normally close type (hereinafter, referred to as ‘NC type’) solenoid valve which is closed in a normal state to maintain the pressure of the accumulator 210 at normal times and is opened when the valve receives an opening signal from the ECU 240 during braking.

The second control valve 222 serving as a pressure reduction control valve is a normally open type (hereinafter, referred to as ‘NO type’) solenoid valve which is opened in a normal state and is closed when the valve receives a closing signal from the ECU 240 during braking.

The third control valve 223 serving as a cutoff valve is a normally open type (hereinafter, referred to as ‘NO type’) solenoid valve which is opened in a normal state and is closed when the valve receives a closing signal from the ECU 240 during braking.

The second control valve 222 and the third control valve 223 employ the NO type solenoid valves so as to release pressures of the boosting chamber 112 and the simulation chamber 111 when the system malfunctions.

Further, pressure sensors 231, 232 and 233 sensing pressures of the accumulator 210, the boosting chamber 112 and the simulation chamber 111 are provided in the hydraulic control unit 200. The pressure sensors 231, 232 and 233 include a first pressure sensor 231 measuring the pressure of the accumulator 210 to maintain the pressure of the accumulator 210 within a designated range, a second pressure sensor 232 measuring the pressure of the boosting chamber 112 to control the pressure of the boosting chamber 112, and a third pressure sensor 233 measuring the pressure of the simulation chamber 111 to judge driver's braking intention and system malfunction. The hydraulic control unit 240 controls the motor 212 and the control valves 221, 222 and 223 based on pressure information measured by the pressure sensors 231, 232 and 233 and pedal displacement information.

The above-described hydraulic control unit 200 may be a module integrated with a single housing block 201. That is, the elements of the hydraulic control unit 200 are integrated into one module and provided within the housing block 201. Thereby, the hydraulic control unit 200 may be assembled with a standardized actuator unit 100, and thus ease in assembly may be obtained.

Hereinafter, operation of the above-described brake device of the electro-hydraulic brake system, i.e., normal braking of the brake device and emergency braking of the brake device due to malfunction of the system, will be described.

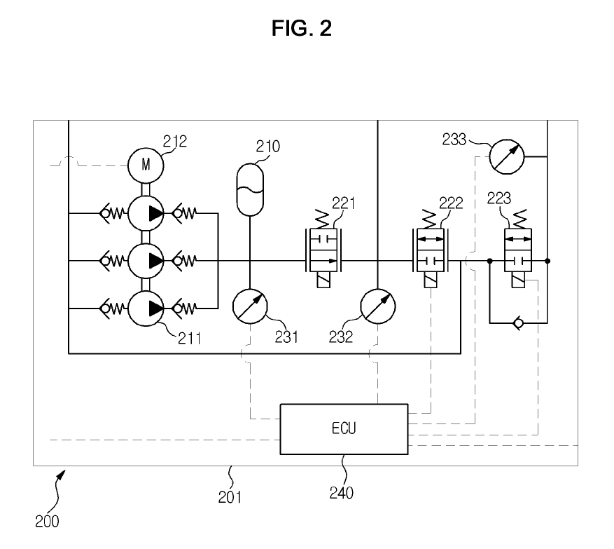

First, with reference to FIGS. 1 and 2, normal braking of the brake device of the electro-hydraulic brake system will be described.

When a driver presses the pedal 10, the push rod 11 connected to the pedal 10 moves forward, i.e., to the left as shown in FIG. 1, and simultaneously, the input rod 115 contacting the push rod 11 moves forward, i.e., to the left as shown in FIG. 1. Here, the clearance S of a designated distance is present between the first piston 121 of the master cylinder 120 and the input rod 115, thereby preventing foot effort of the driver from being transmitted directly to the master cylinder 120.

Braking intention of the driver by the pedal displacement sensor 150 is obtained together with generation of displacement of the pedal 10 by foot effort of the driver, the ECU 240 calculates braking pressure corresponding to the displacement of the pedal 10, and supplies pressure filling the accumulator 210 to the boosting chamber 112 by opening the NC type first control valve 221 while closing the NO type second control valve 222 in order to supply corresponding pressure to the boosting chamber 112. Then, when the pressure of the boosting chamber 112 is raised, the boosting piston 112a pushes the first piston 121 of the master cylinder 120, the first piston 121 moves forward, the clearance S between the first piston 121 and the input rod 115 is maintained, and the pressure of the master cylinder 120 is raised. That is, oil stored in the master cylinder 120 is compressed, thereby generating braking force.

Further, the NO type third control valve 223 disposed at the flow path connecting the simulation chamber 111 and the reservoir 140 is closed simultaneously with sensing of generation of the displacement of the pedal 10, the pressure of the simulation chamber 111 is transmitted to the simulator 130, the reaction force piston 132 moves, and pressure corresponding to load of the reaction force spring 133 supporting the reaction force piston 132 is formed in the simulation chamber 111, thereby providing proper pedal feel to the driver.

If the driver uniformly maintains the pedal 10, both first control valve 221 and the second control valve 222 are closed to maintain the pressure of the boosting chamber 112.

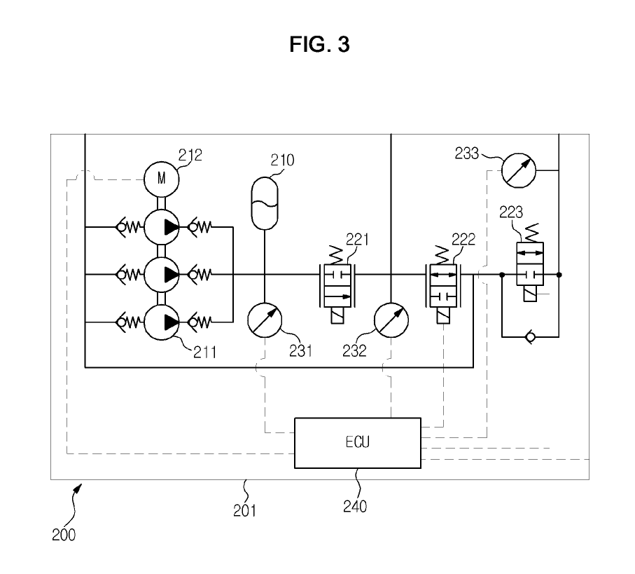

Next, with reference to FIGS. 1 and 3, operation of the hydraulic control unit, if the displacement of the pedal 10 normally operated is decreased or removed, will be described.

After normal braking, when the displacement of the pedal 10 is decreased or the pedal 10 is restored to its initial position by removal of the displacement of the pedal 10, the second control valve 222 is opened to discharge oil within the boosting chamber 112 to the reservoir 140 under the condition that the first control valve 221 is closed, and thus the pressure of the boosting chamber 112 is decreased, thereby generating braking force required by a driver. Accordingly, the pistons 121 and 122 of the master cylinder 120, the boosting piston 112a, the input rod 115 and the push rod 11 are restored to their initial positions. Here, in order to properly adjust the pressure of the boosting chamber 112, pressure information of the boosting chamber 112 is transmitted from the second pressure sensor 232 to the ECU 240. That is, in the above brake device of the electro-hydraulic brake system, in order to judge whether or not the brake device is normally operated, the ECU 240 compares the pressure of the boosting chamber 112 and the pressure of the pedal displacement sensor 150 at normal times.

When the foot effort is completely released from the pedal 10 and thus the pedal 10 is restored to its initial position, the third control valve 223 is opened so that unnecessary pressure does not remain in the simulation chamber 111.

As described above, the brake device of the electro-hydraulic brake system in accordance with the embodiment of the present invention may decrease the pressure in the boosting chamber 112 to support regenerative braking if decrease of hydraulic braking force is required to perform regenerative braking in hybrid vehicles, electric vehicles and fuel cell vehicles, and increase the pressure in the boosting chamber 112 if increase of hydraulic braking force is required. Here, by maintaining the regular clearance S between the first piston 121 of the master cylinder 120 and the input rod 115, driver pedal feel is not changed according to change of the pressure of the master cylinder 120.

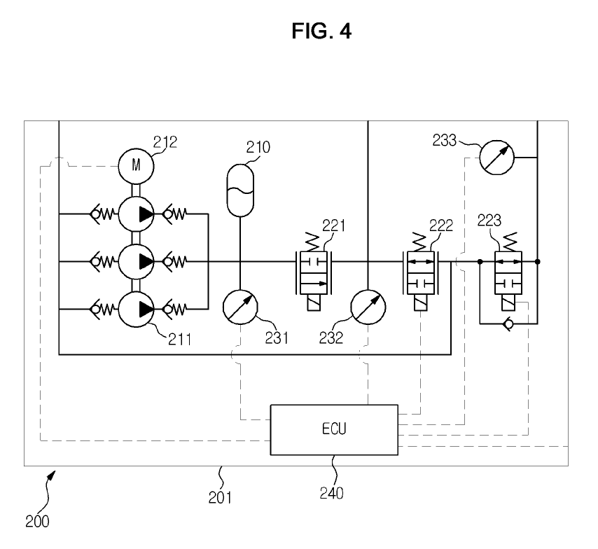

Next, with reference to FIGS. 1 and 4, emergency braking of the brake device of the electro-hydraulic brake system in accordance with the embodiment of the present invention will be described.

If the brake device of the electro-hydraulic brake system is operated in an emergency, i.e., when a driver presses the pedal 10 if the motor 212 and the control valves 221, 222 and 223 are not operated, the push rod 11 connected to the pedal 10 and the input rod 115 move forward, i.e., to the left as shown in FIG. 1. Here, the NC type first control valve 221 maintains the closed state and the NO type second and third control valves 222 and 223 are opened, and thus the pressure in the boosting chamber 112 is not changed. Therefore, the clearance S between the input rod 115 and the first piston 121 is not maintained, the input rod 115 directly contacts the first piston 121 and presses the first piston 121 to form pressure in the master cylinder 120, thereby generating braking force.

In the brake device of the electro-hydraulic brake system in accordance with the embodiment of the present invention, in order to achieve regenerative braking during normal operation, the pressure of the master cylinder 120 and the pressure of the wheel cylinder may be controlled by arbitrarily adjusting the pressure of the boosting chamber 112. Since the pressure of the simulation chamber 111 and the pressure of the boosting chamber 112 are separated by the third control valve 223, although the ECU 240 increases or decreases the pressure of the boosting chamber 112, stable pedal feel may be provided to the driver through the simulator 130.

Consequently, the brake device of the electro-hydraulic brake system in accordance with the embodiment of the present invention may achieve boosting regardless of operation of an engine and thus contribute to improvement of fuel efficiency, and maintain pedal feel of a driver regardless of change of the pressure of the master cylinder 120 due to regenerative braking and other active control and thus support various active control.

As is apparent from the above description, a brake device of an electro-hydraulic brake system for vehicles in accordance with one embodiment of the present invention has effects as follows.

First, the brake device may generate braking force required by a user regardless of whether or not an engine is present and whether or not the engine is operated, thus contributing to improvement of fuel efficiency.

Second, the brake device may maintain stable pedal feel transmitted to a driver even if pressure during braking arbitrarily adjusted.

Third, the brake device has a simple configuration as compared to a conventional negative pressure type booster, does not use suction pressure of an engine, differently from a vacuum brake, and may thus improve fuel efficiency of a vehicle. Further, the brake device has a simple configuration and may thus be easily applied to a small vehicle.

Fourth, the brake device achieves braking of a vehicle when the brake system malfunctions, thus being easily applied to electric vehicles, fuel cell vehicles and hybrid vehicles.

Fifth, the brake device provides a standardized actuator unit of a vehicle and a hydraulic control unit formed as a single module, thus obtaining ease in assembly.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A brake device of an electro-hydraulic brake system for vehicles to electronically control hydraulic pressure of a vehicle comprising:
an actuator unit including:
a master cylinder having two hydraulic circuits and generating hydraulic pressure;
a housing including a boosting chamber provided with a boosting piston contacting the master cylinder to compress the master cylinder, and a simulation chamber divided from the boosting chamber;
an input rod disposed coaxially with the master cylinder to move forward by foot effort of a driver, provided within the housing, passing through the boosting piston, and having a regular clearance with a piston of the master cylinder;
a reservoir connected to the upper portion of the master cylinder and storing oil;
a simulator connected to the simulation chamber by a flow path and providing reaction force of a pedal; and
a pedal displacement sensor sensing displacement of the pedal; and
a hydraulic control unit connected to the reservoir and generating hydraulic pressure,
wherein the hydraulic control unit includes:
an accumulator storing a designated level of pressure to supply the pressure to the boosting chamber;
a pump sucking oil from the reservoir and discharging the sucked oil to the accumulator to form the pressure of the accumulator;
a motor to drive the pump;
a first control valve disposed at a flow path connecting the accumulator and the boosting chamber and controlling oil supplied from the accumulator to the boosting chamber;
a second control valve disposed at a flow path connecting the boosting chamber and the reservoir and controlling oil discharged from the boosting chamber to the reservoir;
a third control valve disposed at a flow path connecting the simulator and the reservoir and controlling oil flowing from the simulation chamber to the reservoir;
pressure sensors sensing the pressures of the accumulator, the boosting chamber and the simulation chamber; and
an electronic control unit (ECU) controlling operation of the motor and the control valves in response to signals from the pedal displacement sensor and the pressure sensors.

2. The brake device according to claim 1, wherein the first control valve serving as a pressure intensification control valve is a normally close type solenoid valve which is closed in a normal state and is opened when the valve receives an opening signal from the ECU.

3. The brake device according to claim 1, wherein the second control valve serving as a pressure reduction control valve is a normally open type solenoid valve which is opened in a normal state and is closed when the valve receives a closing signal from the ECU.

4. The brake device according to claim 1, wherein the third control valve serving as a cutoff valve is a normally open type solenoid valve which is opened in a normal state and is closed when the valve receives a closing signal from the ECU.

5. The brake device according to claim 1, wherein the pressure sensors include a first pressure sensor measuring the pressure of the accumulator, a second pressure sensor measuring the pressure of the boosting chamber, and a third pressure sensor measuring the pressure of the simulation chamber.

6. The brake device according to claim 1, wherein:
an insertion recess into which the input rod is inserted to form the regular clearance therebetween is formed on the first piston of the master cylinder; and
during abnormal operation, the input rod moves as much as the clearance with the piston, and then mechanically contacts the piston to transmit force applied to the input rod.

7. The brake device according to claim 1, wherein the hydraulic control unit is a module integrated with a single housing block.

8. The brake device according to claim 7, wherein the hydraulic control unit being the integrated module is assembled with the actuator unit.

9. The brake device according to claim 1, wherein an O-ring is installed on the outer circumferential surface of the boosting piston so as to prevent the pressure and oil of the boosting chamber from leaking to the master cylinder.

10. The brake device according to claim 1, wherein an O-ring is installed on the outer circumferential surface of one end of the input rod contacting a push rod of the pedal so as to prevent the pressure and oil of the simulation chamber from leaking to the outside of the simulation chamber.

11. The brake device according to claim 1, wherein:
a diaphragm is formed within the housing so as to divide the boosting chamber and the simulation chamber from each other; and
an O-ring is provided between the input rod passing through the diaphragm and the diaphragm so as to isolate the pressure and oil of the boosting chamber and the pressure and oil of the simulation chamber from each other.
